(19) United States
(12) Patent Application Publication
(10) Pub. No.: US 2011/0073790 A1
(43) Pub. Date: Mar. 31, 2011

(54) Electromagnetic Valve

(76) Inventor: Ti-Hua Ko, Taipei (TW)

(21) Appl. No.: 12/568,676

(22) Filed: Sep. 29, 2009

(51) Int. Cl. F16K 31/06

(52) U.S. Cl. 251/129.15

(57) ABSTRACT

An electromagnetic valve includes an electromagnetic coil module which includes a coiling body defining a receiving passage therein having two opposite end mouths, and a coil coiled around the coiling body. The electromagnetic coil module produces a magnetic field when a current flows through the coil. A slide body is moveably disposed in the receiving passage of the coiling body. Two magnetic conductors are mounted to the corresponding end mouths of the receiving passage of the coiling body respectively. A permanent magnet is embedded in the slide body with two opposite magnetic ends thereof fronting the corresponding magnetic conductors respectively. The permanent magnet under the combined actions of the magnetic attraction of the magnetic conductors and the magnetic field produced by the electromagnetic coil module drives the slide body to relatively move between the magnetic conductors.

### BACKGROUND OF THE INVENTION

1. Field of the Invention

The present invention generally relates to an electronic switch, and more particularly to an electromagnetic valve.

2. The Related Art

In the automation field, electromagnetic valves are often acted as electronic switches with an automatic control function to be widely used in many automated machines and electronic products. The conventional electromagnetic valve achieves the automatic control action by means of making a slide body relatively move there and back. The relative movement of the slide body is generally achieved by means of elastic elements such as springs. However, because the space in the electromagnetic valve is small, it is difficult to mount the elastic element in the electromagnetic valve. In addition, the elastic element often has a problem of elastic fatigue, thereby reducing the effectiveness of the electromagnetic valve. Therefore, an electromagnetic valve capable of overcoming the foregoing problems is required.

### SUMMARY OF THE INVENTION

An object of the present invention is to provide an electromagnetic valve including an electromagnetic coil module, a slide body, two magnetic conductors and a permanent magnet. The electromagnetic coil module includes a coiling body and a coil coiled around the coiling body. The coiling body defines a receiving passage therein having two opposite end mouths. The electromagnetic coil module produces a magnetic field when a current flows through the coil. The slide body is moveably disposed in the receiving passage of the coiling body. The two magnetic conductors are mounted to the corresponding end mouths of the receiving passage of the coiling body respectively. The permanent magnet is embedded in the slide body with two opposite magnetic ends thereof fronting the corresponding magnetic conductors respectively. The permanent magnet under the combined actions of the magnetic attraction of the magnetic conductors and the magnetic field produced by the electromagnetic coil module drives the slide body to relatively move between the magnetic conductors so as to achieve corresponding control actions. So the electromagnetic valve has a simple structure and a relatively longer life.

### BRIEF DESCRIPTION OF THE DRAWINGS

The present invention will be apparent to those skilled in the art by reading the following description, with reference to the attached drawings, in which:

FIG. 1 is an exploded perspective view of an electromagnetic valve according to a first embodiment of the present invention;

FIG. 2 is a cross-sectional view of the electromagnetic valve of FIG. 1, wherein the electromagnetic valve is assembled and lying in one work state;

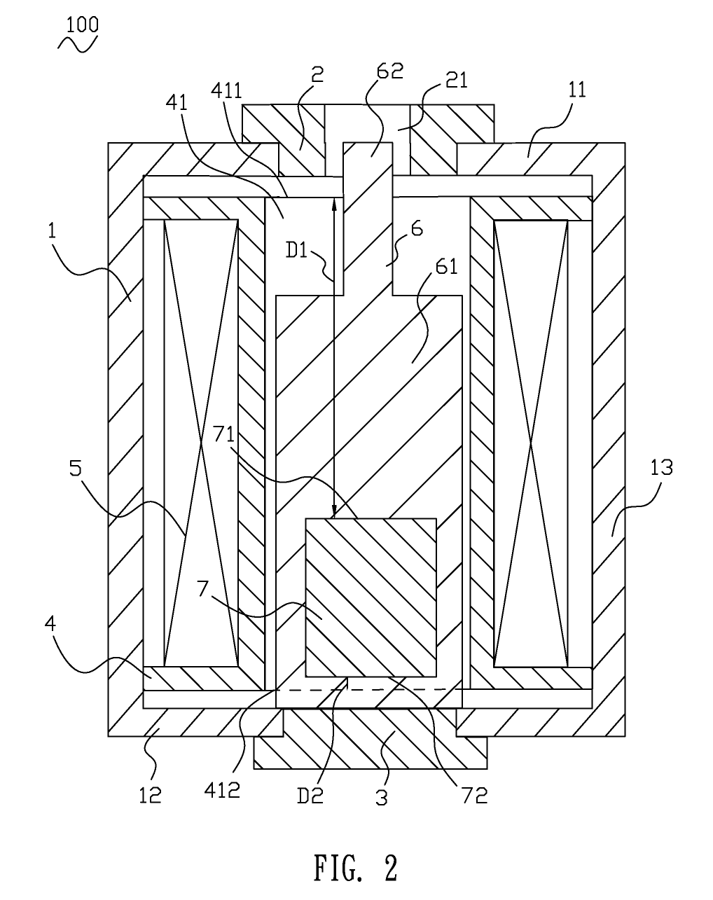

FIG. 3 is a cross-sectional view of the electromagnetic valve of FIG. 1, wherein the electromagnetic valve is assembled and lying in another work state;

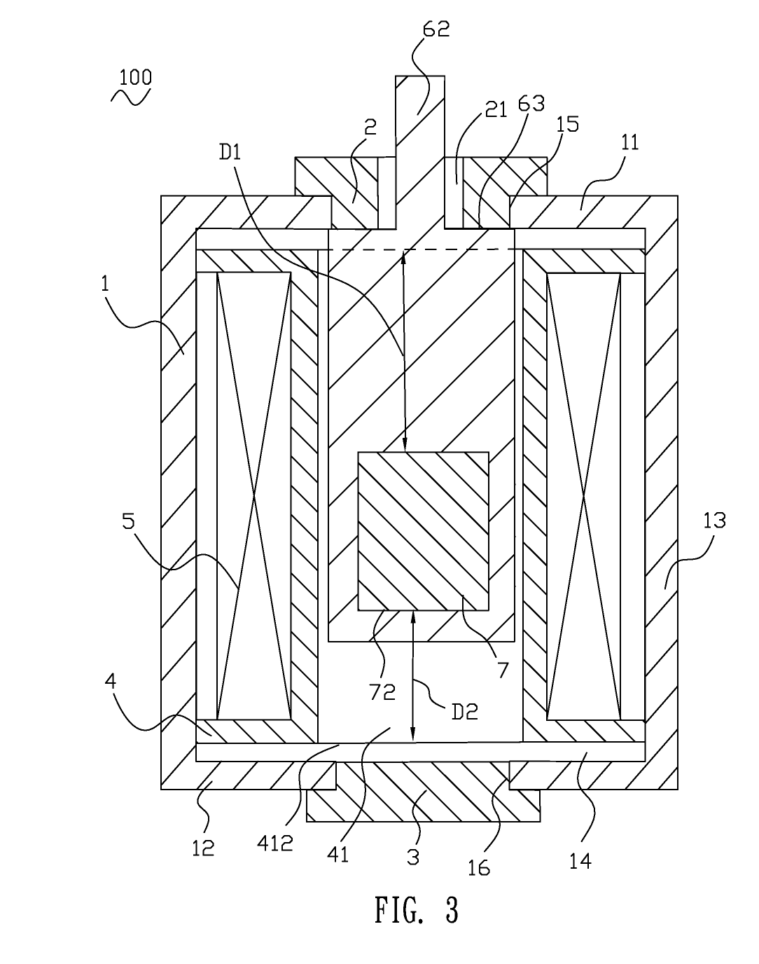

FIG. 4 is an exploded perspective view of an electromagnetic valve according to a second embodiment of the present invention;

FIG. 5 is a cross-sectional view of the electromagnetic valve of FIG. 4, wherein the electromagnetic valve is assembled and lying in one work state; and

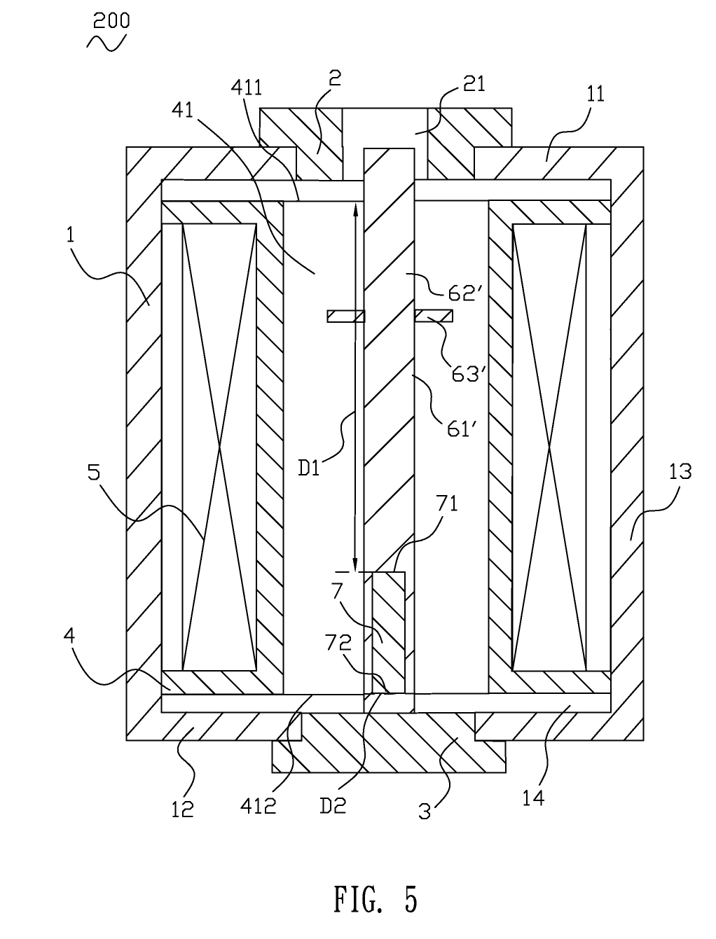

FIG. 6 is a cross-sectional view of the electromagnetic valve of FIG. 4, wherein the electromagnetic valve is assembled and lying in another work state.

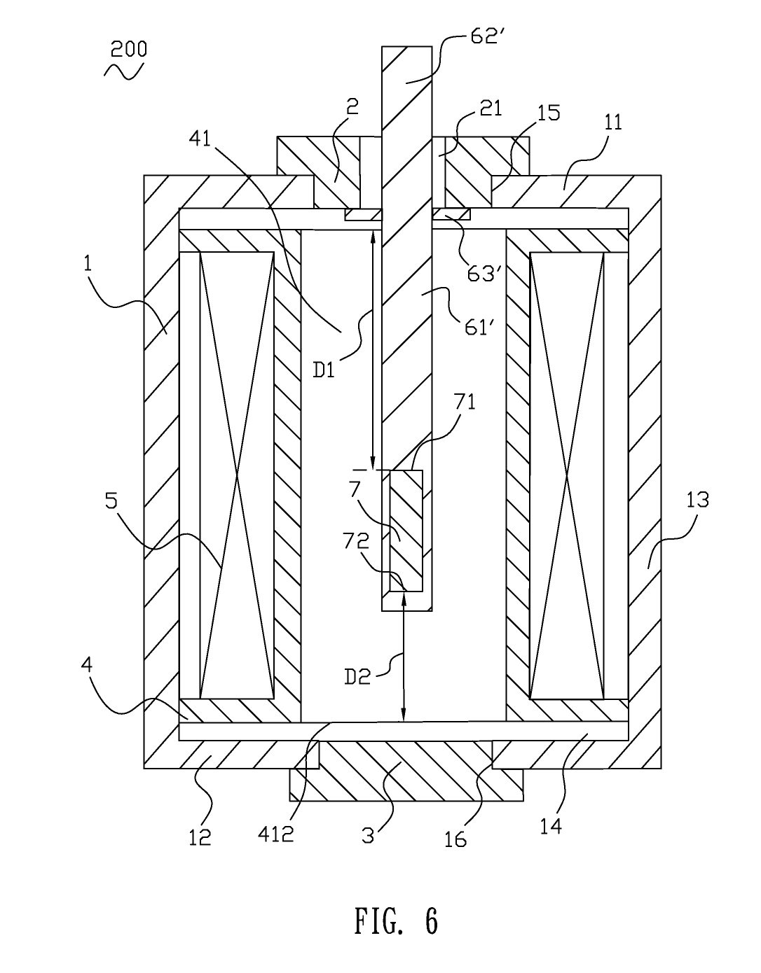

### DETAILED DESCRIPTION OF THE PREFERRED EMBODIMENT

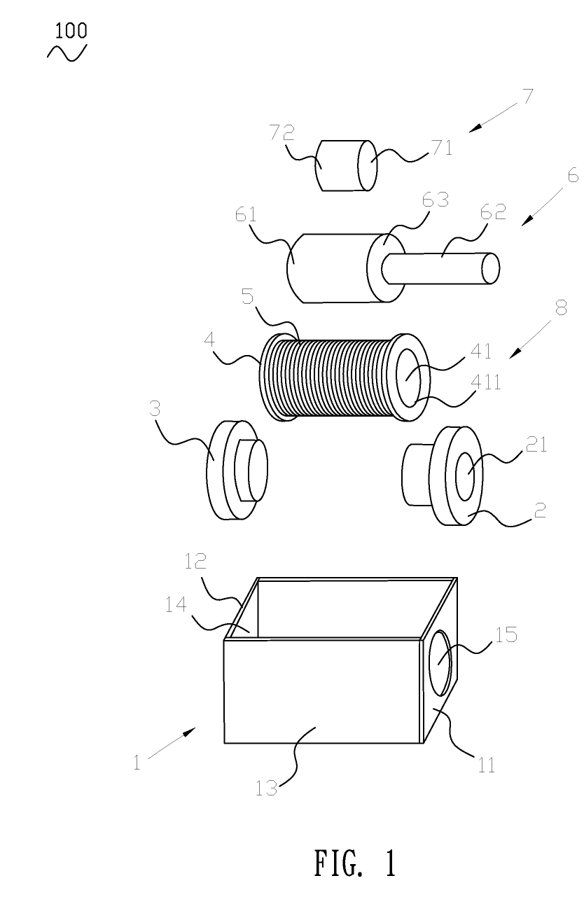

With reference to FIGS. 1˜3, an electromagnetic valve 100 according to a first embodiment of the present invention includes a housing 1 made of metal material, two magnetic conductors designated as a first magnetic conductor 2 and a second magnetic conductor 3 respectively, an electromagnetic coil module 8, a slide body 6 and a permanent magnet 7.

The housing 1 has a first board 11, a second board 12 spaced from and parallel to the first board 11, and a pair of parallel third boards 13 perpendicularly connecting the first board 11 and the second board 12 to make the housing 1 show a rectangular hollow shape. Accordingly, a rectangular receiving chamber 14 is surrounded by the first board 11, the second board 12 and the pair of third boards 13. A first fixing hole 15 is opened in a center of the first board 11 and a second fixing hole 16 is opened in a center of the second board 12 to face the first fixing hole 15.

The first magnetic conductor 2 and the second magnetic conductor 3 are respectively fixed in the first fixing hole 15 and the second fixing hole 16 of the housing 1. A center of the first magnetic conductor 2 defines a columned inserting perforation 21 penetrating therethrough to communicate with the receiving chamber 14 and face the second magnetic conductor 3. The electromagnetic coil module 8 includes a cylindrical coiling body 4 and a coil 5 coiled around the coiling body 4. Accordingly, the coiling body 4 defines a columned receiving passage 41 penetrating therethrough and having the same axis as the coiling body 4. Two opposite end mouths of the receiving passage 41 are respectively defined as a first end mouth 411 and a second end mouth 412. The electromagnetic coil module 8 is mounted in the receiving chamber 14 of the housing 1 with the second end mouth 412 facing the second magnetic conductor 3 and the first end mouth 411 facing the first magnetic conductor 2 to make the inserting perforation 21 lay in line with the receiving passage 41.

The slide body 6 has a columned base portion 61 and a slide rod 62 extended from a middle of one end surface of the base portion 61 and having a narrower diameter than the base portion 61. Accordingly, an annular stopping portion 63 is formed at the junction of the base portion 61 and the slide rod 62. The slide body 6 is slideably disposed in the receiving passage 41 of the coiling body 4 with the slide rod 62 being always inserted in the inserting perforation 21 of the first magnetic conductor 2. The permanent magnet 7 is of substantially columned shape, and two opposite ends thereof are defined as a first magnetic end 71 and a second magnetic end 72 respectively. The permanent magnet 7 is embedded in the base portion 61 with the first magnetic end 71 fronting the first magnetic conductor 2 to form a first distance D1 between the first magnetic end 71 and the first end mouth 411 of the coiling body 4, and the second magnetic end 72 fronting the second magnetic conductor 3 to form a second distance D2 between the second magnetic end 72 and the second end mouth 412 of the coiling body 4. Furthermore, the first distance D1 is always longer than the second distance D2 so as to ensure the movement direction of the slide body 6 to further prevent the slide body 6 from abnormally swaying.

When there is current flowed through the coil 5, a magnetic field correspondingly produced to make the permanent magnet 7 adsorbed by the first magnetic conductor 2 or the second magnetic conductor 3. When the magnetic field has the uniform polarity to the permanent magnet 7, the permanent magnet 7 under the combined action of the magnetic field and the magnetic attraction of the first magnetic conductor 2 drives the base portion 61 to move toward the first end mouth 411 until the stopping portion 63 is against the first magnetic conductor 2. At this time, the slide rod 62 stretches out of the first magnetic conductor 2 through the inserting perforation 21. When the polarity of the magnetic field is opposite to that of the permanent magnet 7, the permanent magnet 7 under the combined action of the magnetic field and the magnetic attraction of the second magnetic conductor 3 drives the slide body 6 to move toward the second end mouth 412 until an end of the base portion 61 opposite to the slide rod 62 is against the second magnetic conductor 3. At this time, the slide rod 62 is withdrawn back into the inserting perforation 21. Therefore, corresponding control actions can be achieved by means of the permanent magnet 7 driving the slide body 6 to relatively move under the combined actions of the magnetic field and the magnetic attraction of the magnetic conductors 2, 3.

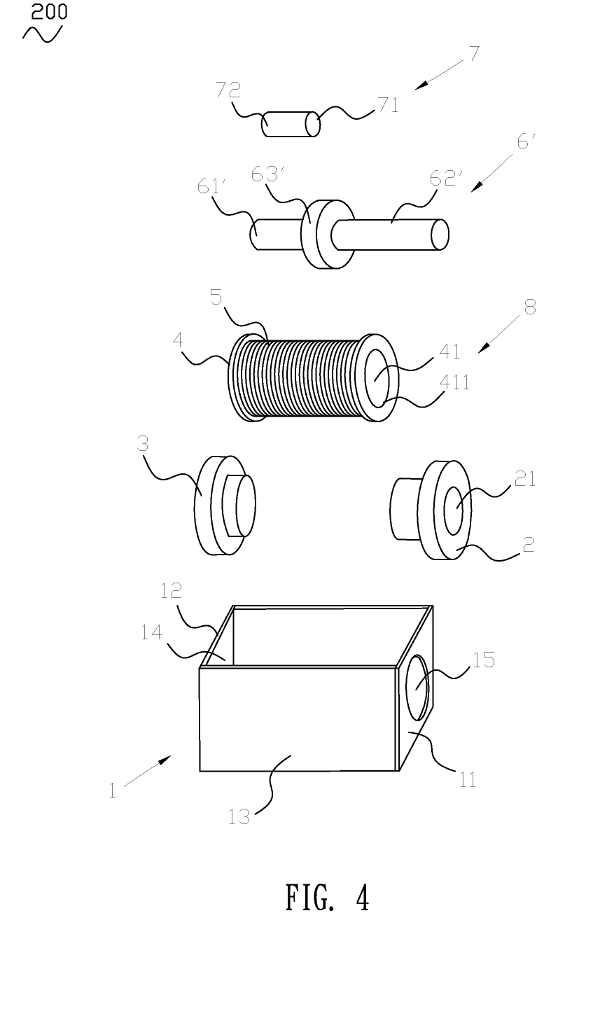

Referring to FIGS. 4˜6, an electromagnetic valve 200 according to a second embodiment of the present invention is shown and similar to the electromagnetic valve 100 in the first embodiment. The difference therebetween is that the electromagnetic valve 200 has a slide body 6′ different from the slide body 6 of the electromagnetic valve 100 of the first embodiment. In the second embodiment, a base portion 61′ of the slide body 6′ has a substantially equal diameter to a slide rod 62′, and an annular stopping portion 63′ is formed by means of protruding outward from the junction of the base portion 61′ and the slide rod 62′. The electromagnetic valve 200 has the same working principle as the electromagnetic valve 100, so it will not be described anymore.

As described above, the permanent magnet 7 is embedded in the slide body 6(6′), and furthermore, the magnetic conductors 2, 3 are disposed to front the corresponding magnetic ends 71, 72 of the permanent magnet 7 respectively, so that the permanent magnet 7 under the combined actions of the magnetic attraction of the magnetic conductors 2, 3 and the magnetic field produced by the electromagnetic coil module 8 can drive the slide body 6(6′) to relatively move so as to achieve the corresponding control actions. So the electromagnetic valve 100(200) of the present invention has a simple structure and a relatively longer life.

What is claimed is:

1. An electromagnetic valve, comprising:
an electromagnetic coil module including a coiling body and a coil coiled around the coiling body, the coiling body defining a receiving passage therein having two opposite end mouths, the electromagnetic coil module producing a magnetic field when a current flows through the coil;
a slide body moveably disposed in the receiving passage of the coiling body;
two magnetic conductors mounted to the corresponding end mouths of the receiving passage of the coiling body respectively; and
a permanent magnet embedded in the slide body with two opposite magnetic ends thereof fronting the corresponding magnetic conductors respectively, wherein the permanent magnet under the combined actions of the magnetic attraction of the magnetic conductors and the magnetic field produced by the electromagnetic coil module drives the slide body to relatively move between the magnetic conductors.

2. The electromagnetic valve as claimed in claim 1, wherein two different distances are respectively formed between the magnetic ends of the permanent magnet and the corresponding end mouths of the receiving passage of the coiling body, one of the two distances is always longer than the other distance to ensure the movement direction of the slide body.

3. The electromagnetic valve as claimed in claim 1, wherein the slide body has a base portion and a slide rod further extending from one end of the base portion, a stopping portion is formed at the junction of the base portion and the slide rod, the slide body can move to make the slide rod pass through and stretch out of one corresponding magnetic conductor until the stopping portion is against the one corresponding magnetic conductor.

4. The electromagnetic valve as claimed in claim 3, wherein the slide rod has a narrower diameter than the base portion.

5. The electromagnetic valve as claimed in claim 3, wherein the slide rod has a substantially equal diameter to the base portion, the stopping portion is formed by means of protruding outward from the junction of the base portion and the slide rod.

6. The electromagnetic valve as claimed in claim 1, further comprising a housing defining a receiving chamber therein, the electromagnetic coil module being received in the receiving chamber, the magnetic conductors being fastened in two opposite boards of the receiving chamber respectively and facing the corresponding end mouths of the receiving passage of the coiling body respectively, wherein the slide body can move to make one end thereof pass through one corresponding magnetic conductor and further stretch out of the housing.
